(19) United States
(12) Patent Application Publication
(10) Pub. No.: US 2026/0091594 A1
(43) Pub. Date: Apr. 2, 2026

(54) METHOD OF GENERATING DOT DATA AND PRINTING APPARATUS

(71) Applicant: SEIKO EPSON CORPORATION, Tokyo (JP)

(72) Inventor: Gakuji YAMAMOTO, SHIOJIRI-SHI (JP)

(21) Appl. No.: 19/341,424

(22) Filed: Sep. 26, 2025

(30) Foreign Application Priority Data
Sep. 30, 2024 (JP) 2024-170138

(51) Int. Cl. B41J 2/21; G06K 15/02

(52) U.S. Cl. CPC B41J 2/2135; B41J 2/2128; G06K 15/1881

(57) ABSTRACT

A determination area includes a cross area including a target pixel and both sides in a first direction and a second direction of the target pixel, and corner pixels located at four corners. The corner pixels at the four corners include a first corner pixel and a second corner pixel that is not located at a diagonal position from the first corner pixel in the determination area. In a detection step, the target pixel is detected as a processing target inside portion when a first condition that the cross area is located in a dark area, the first corner pixel is located in a surrounding area, and three corner pixels other than the first corner pixel are located in the dark area in the determination area is satisfied, and the target pixel is detected as the processing target inside portion when a second condition that the cross area is located in the dark area, the second corner pixel is located in the surrounding area, and three corner pixels other than the second corner pixel are located in the dark area in the determination area is satisfied.

The present application is based on, and claims priority from JP Application Serial Number 2024-170138, filed Sep. 30, 2024, the disclosure of which is hereby incorporated by reference herein in its entirety.

### BACKGROUND

### 1. Technical Field

The present disclosure relates to a method of generating dot data representing positions of dots to be formed by ink from a print head, and a printing apparatus.

### 2. Related Art

As a printing apparatus, an inkjet printer that forms a print image by ejecting ink droplets from a print head to a print medium is known. Since the ink droplet is a liquid, an edge portion of an area darker than the surroundings such as a character or a bar code may bleed on the printing medium to thereby deteriorate printing quality in some cases. In order to prevent such deterioration of printing quality, it is conceivable to suppress the ejection of the ink over the entire edge of the dark area. In a method of generating ejection position data disclosed in JP-A-2022-81922, processing of changing a pixel value from an ejection value to a non-ejection value by one pixel at both sides of a line having a width of no smaller than three pixels is performed.

JP-A-2022-81922 is an example of the related art.

For example, when the pixel value is changed from the ejection value to the non-ejection value over the entire edge with respect to a thin oblique line such as a glance-off portion of a small character, the oblique line becomes too thin, and deterioration of an object including the oblique line becomes conspicuous. In the method of generating the ejection position data described above, the deterioration of the oblique line is not considered.

### SUMMARY

A method of generating dot data according to the present disclosure is a method of generating dot data configured to represent positions of dots to be formed of ink from a print head, in which
an image including a plurality of pixels arranged in a first direction and a second direction crossing the first direction includes a surrounding area and a dark area darker than the surrounding area,
the method having a configuration including:
a detection step of detecting a target pixel belonging to at least a part of a detection target area of the image as a processing target inside portion when a rectangular determination area centered on the target pixel satisfies a predetermined edge inside condition including the surrounding area and the dark area; and
a generation step of generating the dot data from the image so that an amount of the ink ejected from the print head to the processing target inside portion is reduced, in which
the determination area includes a cross area including the target pixel and both sides of the target pixel in the first direction and the second direction in the determination area, and corner pixels at four corners of the determination area,
the corner pixels located at the four corners including a first corner pixel and a second corner pixel that is not located at a diagonal position from the first corner pixel in the determination area, and
in the detection step,
the target pixel is detected as the processing target inside portion when a first condition that the cross area is located in the dark area, the first corner pixel is located in the surrounding area, and the three corner pixels other than the first corner pixel are located in the dark area is satisfied in the determination area as the edge inside condition, and
the target pixel is detected as the processing target inside portion when a second condition that the cross area is located in the dark area, the second corner pixel is located in the surrounding area, and the three corner pixels other than the second corner pixel are located in the dark area is satisfied in the determination area as the edge inside condition.

Further, a printing apparatus according to the present disclosure is a printing apparatus configured to form a print image at a print medium with ink, and having a configuration including:
a print head configured to eject the ink; and
a control unit configured to control ejection of the ink from the print head to the print medium so that dots constituting the print image are formed at the print medium, in which
an image including a plurality of pixels arranged in a first direction and a second direction crossing the first direction includes a surrounding area and a dark area darker than the surrounding area,
the control unit executes
detection processing of detecting a target pixel belonging to at least a part of a detection target area of the image as a processing target inside portion when a rectangular determination area centered on the target pixel satisfies a predetermined edge inside condition including the surrounding area and the dark area, and
ejection control processing of controlling ejection of the ink from the print head to the print medium so that an amount of the ink ejected to the processing target inside portion is reduced,
the determination area includes a cross area including the target pixel and both sides of the target pixel in the first direction and the second direction in the determination area, and corner pixels at four corners of the determination area,
the corner pixels located at the four corners including a first corner pixel and a second corner pixel that is not located at a diagonal position from the first corner pixel in the determination area, and
in the detection processing, the control unit is configured to
detect the target pixel as the processing target inside portion when a first condition that the cross area is located in the dark area, the first corner pixel is located in the surrounding area, and the three corner pixels other than the first corner pixel are located in the dark area is satisfied in the determination area as the edge inside condition, and
detect the target pixel as the processing target inside portion when a second condition that the cross area is located in the dark area, the second corner pixel is located in the surrounding area, and the three corner pixels other than the second corner pixel are located in the dark area is satisfied in the determination area as the edge inside condition.

### BRIEF DESCRIPTION OF THE DRAWINGS

FIG. 1 is a diagram schematically showing a configuration example of a printing apparatus.

FIG. 2 is a diagram schematically showing an example of a nozzle surface of a print head.

FIG. 3 is a flowchart schematically showing an example of print control processing.

FIG. 4 is a diagram schematically showing an example of generating a corrected image in which an ink amount in a processing target inside portion is reduced from an input image.

FIG. 5 is a diagram schematically showing an example of combining individual reference patterns.

FIG. 6 a diagram schematically showing an example of forming a print image from dot data.

FIG. 7 is a diagram schematically showing another example of generating the corrected image in which the ink amount in the processing target inside portion is reduced from the input image.

FIG. 8 is a diagram schematically showing an example of forming a print image in which the ink amount in an edge portion of the processing target is reduced from the input image.

FIG. 9 is a diagram schematically showing another example of forming the print image from the dot data.

FIG. 10A is a diagram schematically showing an example of an inside ink amount designation screen, FIG. 10B is a diagram schematically showing an example of a dark area designation screen, and FIG. 10C is a diagram schematically showing an example of an edge depth designation screen.

FIG. 11 is a diagram schematically showing an example of generating a corrected image by deepening the processing target inside portion.

FIG. 12A is a diagram schematically showing an example of an object designation screen, and FIG. 12B is a diagram schematically showing an example of a detection target area contained in an image.

FIG. 13 is a diagram schematically showing a comparative example of forming a print image from an input image.

### DESCRIPTION OF EMBODIMENTS

An embodiment of the present disclosure will hereinafter be described. Obviously, the following embodiment is nothing more than exemplifying the present disclosure, and all the features shown in the embodiment are not necessarily essential to the solution disclosed herein.

### (1) Overview of Aspects Included in Present Disclosure

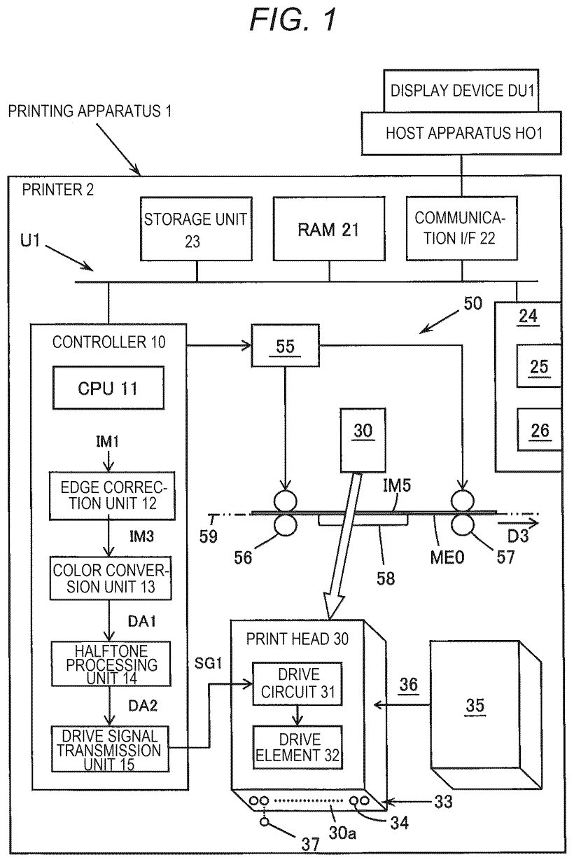

An overview of aspects included in the present disclosure will first be described with reference to examples shown in FIGS. 1 to 13. Note that the drawings of the present application are diagrams schematically illustrating the examples, and in order to make each portion of these drawings have a recognizable size, the scale of each portion may be different from the actual scale in some cases, the enlargement ratio may be different between directions illustrated in these drawings in some cases, and the drawings may not be consistent with each other in some cases. Obviously, each element in the present aspects is not limited to a specific example denoted by the reference symbol. In “Overview of Aspects Included in Present Disclosure,” a description in parentheses means supplementary description of the term immediately before the parentheses.

Further, in the present application, a numerical range “Min to Max” means a range no less than a minimum value Min and no more than a maximum value Max.

### Aspect 1

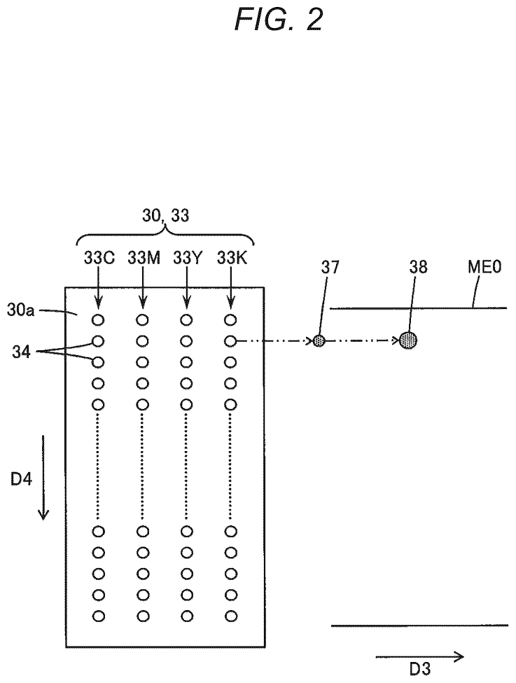

As illustrated in FIGS. 2 to 7 and so on, a method of generating dot data according to an aspect is a dot data generation method that generates dot data DA2 representing positions of dots 38 to be formed with ink 36 from a print head 30, and includes the following steps. Note that an image IM1 including a plurality of pixels PX0 arranged in a first direction D1 and a second direction D2 orthogonal to the first direction D1 includes a surrounding area AR2 and a dark area AR3 darker than the surrounding area AR2.
(a1) A detection step ST1 of detecting a target pixel PX1 belonging to at least a part of a detection target area AR1 of the image IM1 as a processing target inside portion F1 when a rectangular determination area AD0 centered on the target pixel PX1 satisfies a predetermined edge inside condition (e.g., a pixel arrangement of a reference pattern P0) including the surrounding area AR2 and the dark area AR3.
(a2) A generation step ST2 of generating the dot data DA2 from the image IM1 such that an amount of the ink 36 to be ejected from the print head 30 to the processing target inside portion F1 decreases to a value including 0.

The determination area AD0 includes a cross area PX10 including the target pixel PX1 and both sides of the target pixel PX1 in the first direction D1 and the second direction D2 in the determination area AD0, and corner pixels PX3 located at four corners of the determination area AD0. The corner pixels PX3 located at the four corners include a first corner pixel PX31 and a second corner pixel PX32 that is not located at a diagonal position from the first corner pixel PX31 in the determination area AD0. In the detection step ST1, when a first condition (e.g., a pixel arrangement of a reference pattern P1) that the cross area PX10 is located in the dark area AR3, the first corner pixel PX31 is located in the surrounding area AR2, and the three corner pixels PX3 excluding the first corner pixel PX31 are located in the dark area AR3 in the determination area AD0 is satisfied as the edge inside condition (P0), the target pixel PX1 is detected as the processing target inside portion F1. In that detection step ST1, when a second condition (e.g., a pixel arrangement of a reference pattern P2) that the cross area PX10 is located in the dark area AR3, the second corner pixel PX32 is located in the surrounding area AR2, and the three corner pixels PX3 excluding the second corner pixel PX32 are located in the dark area AR3 in the determination area AD0 is satisfied as the edge inside condition (P0), the target pixel PX1 is detected as the processing target inside portion F1.

Accordingly, an amount of the ink 36 to be ejected to a portion slightly inner side of the edge portion along any one of the two oblique directions is reduced. Accordingly, it is possible to avoid the disadvantage that the oblique edge portion of the object such as a thin oblique line including a glance-off portion of a small character becomes too thin while obtaining the effect of suppressing the degradation of the printing quality due to bleeding of the ink 36. Therefore, according to the aspect described above, it is possible to provide the method of generating the dot data capable of suppressing the degradation of the printing quality due to the bleeding of the ink while suppressing the deterioration of the oblique edge portion in the two oblique directions.

Note that the “generation step ST2 of generating the dot data DA2 from the image IM1 such that an amount of the ink 36 to be ejected to the processing target inside portion F1 decreases to a value including 0” is intended to generate the dot data DA2 so that the amount of the ink 36 to be ejected to the processing target inside portion F1 becomes 0 or the amount of the ink is reduced in a range larger than 0. Substantially the same interpretation may be applied to “such that something is reduced to a value including 0” appearing below.

Various examples are conceivable as the aspect described above.

The size of the dot may be changeable. Therefore, the dot data may be binary data representing the presence or absence of dot formation, or may be multi-valued data of three or more values representing the dot formation state.

The detection target area may be the whole of an image or a part of the image.

The rectangular determination area includes a square determination area.

The decrease in the amount of ink to be ejected to the processing target inside portion includes that the ink is not ejected to the processing target inside portion.

In the present application, “first”, “second”, and so on are terms used to identify a plurality of elements having similarities, and do not mean the order.

Obviously, the additional remarks described above also apply to the following aspects.

### Aspect 2

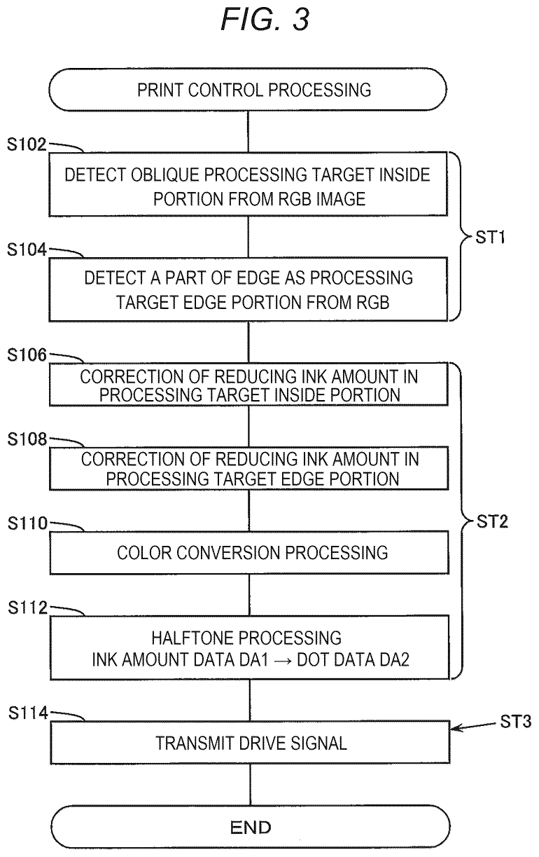

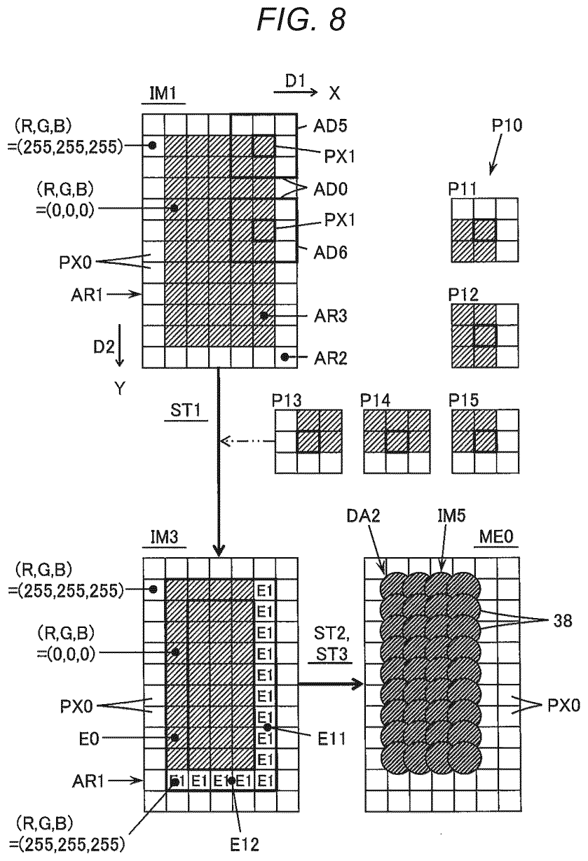

As illustrated in FIGS. 3 and 8, in the detection step ST1, out of the edges E0 existing in the detection target area AR1, at least one of a first edge portion E11 existing at one side in the first direction D1 of the dark area AR3 and a second edge portion E12 existing at one side in the second direction D2 of the dark area AR3 may be detected as the processing target edge portion E1. In the generation step ST2, the dot data DA2 may be generated from the image IM1 such that the amount of the ink 36 to be ejected from the print head 30 to the processing target edge portion E1 is reduced to a value including 0.

Accordingly, the amount of the ink 36 ejected not to the entire edge E0 existing in the detection target area AR1, but to at least one of the first edge portion E11 existing at one side in the first direction D1 of the dark area AR3 and the second edge portion E12 existing at one side in the second direction D2 of the dark area AR3, is reduced. Accordingly, it becomes possible to avoid the disadvantage that an object such as a barcode or a fine character becomes too thin while obtaining an effect of suppressing the degradation of the printing quality due to the bleeding of the ink 36. Therefore, according to the aspect described above, it is possible to provide the method of generating the dot data capable of suppressing the degradation of the printing quality due to the bleeding of the ink while suppressing deterioration of thin lines due to the fact that the ink is not ejected over the entire edge.

Various examples are conceivable as the aspect described above.

For example, when the first direction is a left-right direction, it does not mean that the first edge portion exists at both the left and right sides in the dark area, but means that the first edge portion exists at the left side or the right side of the dark area. When the second direction is an up-down direction, it does not mean that the second edge portion exists at both the upper and lower sides in the dark area, but means that the first edge portion exists at the upper side or the lower side of the dark area. Of course, the first direction may be the up-down direction, and the second direction may be the left-right direction.

The decrease in the amount of ink to be ejected to the processing target edge portion includes that the ink is not ejected to the processing target edge portion.

Obviously, the additional remarks described above also apply to the following aspects.

### Aspect 3

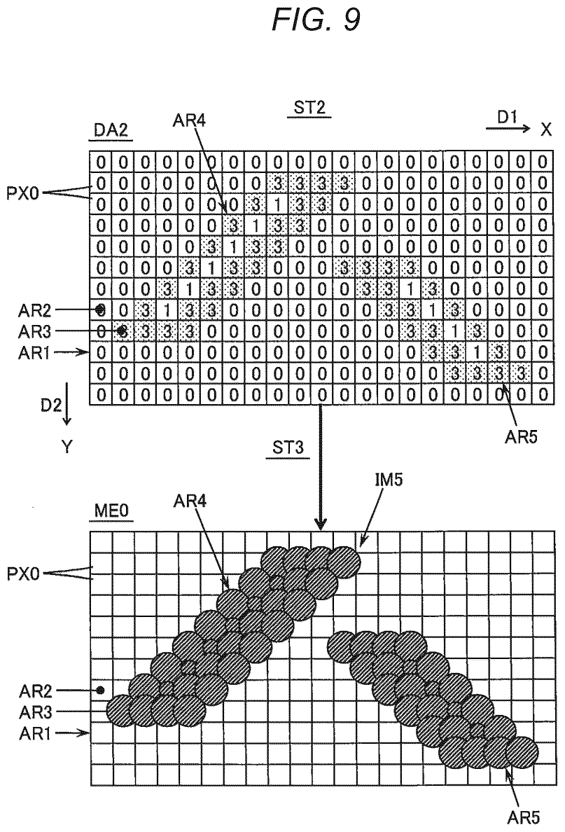

As illustrated in FIGS. 8 and 9, in the generation step ST2, an amount of the ink 36 to be ejected from the print head 30 to the processing target edge portion E1 may be made smaller than an amount of the ink 36 to be ejected from the print head 30 to the processing target inside portion F1.

Since the amount of the ink to be ejected to the processing target edge portion E1 is smaller than the amount of the ink to be ejected to the processing target inside portion F1, the ink 36 is prevented from bleeding so as to spread from the edge portion. Therefore, in the aspect described above, it is possible to further suppress the degradation of the printing quality of an object such as a barcode or a fine character due to the bleeding of the ink.

### Aspect 4

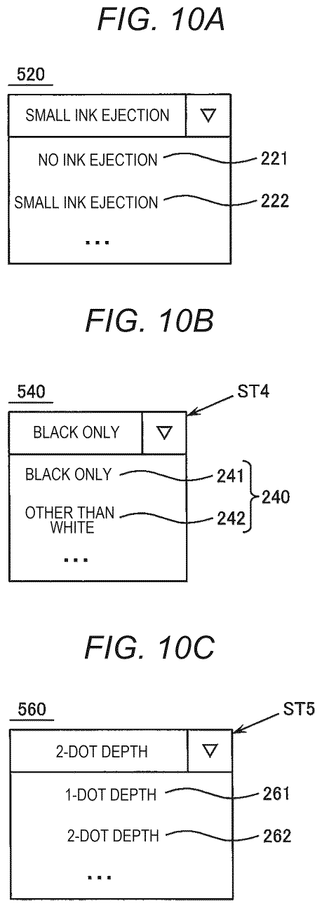

As illustrated in FIG. 10B, the present method of generating the dot data may further include the following step.
(a3) A color designation step ST4 of receiving designation of an option 240 to be applied to the dark area AR3 from a plurality of options 240 including a predetermined color (e.g., “BLACK ONLY” item 241) and a predetermined color range (e.g., “OTHER THAN WHITE” item 242).

In the detection step ST1, when the predetermined color (241) is designated, the target pixel PX1 may be detected as the processing target inside portion F1 when a distribution of the dark area AR3 having the predetermined color (241) and the surrounding area AR2 satisfies the edge inside condition (P0) in the determination area AD0. Further, in the detection step ST1, when the predetermined color range (242) is designated, the target pixel PX1 may be detected as the processing target inside portion F1 when a distribution of the dark area AR3 within the predetermined color range (242) and the surrounding area AR2 satisfies the edge inside condition (P0) in the determination area AD0.

When an object such as a thin oblique line has the predetermined color (241) and the predetermined color (241) is designated, a high-quality print image IM5 due to the reduction of the amount of the ink in the processing target inside portion F1 can be obtained with respect to the object having the predetermined color (241). When an object is within the predetermined color range (242) and the predetermined color range (242) is designated, the high-quality print image IM5 due to the reduction of the amount of the ink in the processing target inside portion F1 can be obtained with respect to the object within the predetermined color range (242). Therefore, in the aspect described above, it is possible to obtain a high-quality print image in accordance with the color of the object such as a thin oblique line.

### Aspect 5

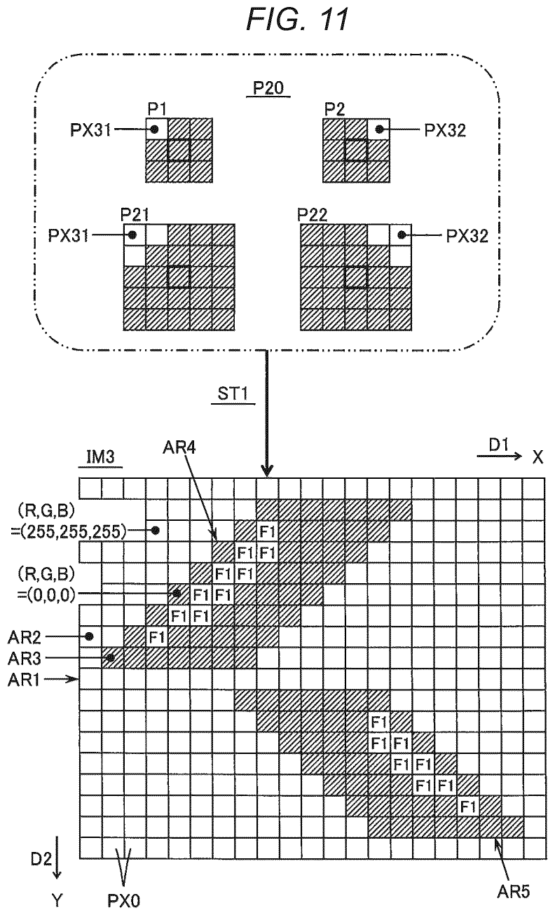

As illustrated in FIGS. 10C and 11, the present method of generating the dot data may further include the following step.
(a4) An edge depth designation step ST5 of receiving designation of a depth of the processing target inside portion F1.

Note that the depth of the processing target inside portion F1means the extent to which the processing target inside portion F1 enters the inside of the dark area AR3 beyond the edge E0 located at a boundary portion between the dark area AR3 and the surrounding area AR2.

In the detection step ST1, the processing target inside portion F1 may be detected so that the depth thus designated is achieved.

In this case, the depth of the processing target inside portion F1 to be detected can be adjusted to an intention of the user. Therefore, in the aspect described above, it is possible to improve the image quality of the print image in accordance with the intention of the user.

### Aspect 6

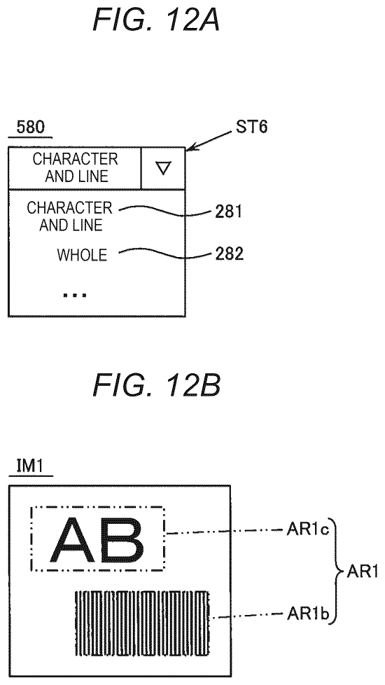

As illustrated in FIGS. 12A and 12B, the present method of generating the dot data may further include the following step.
(a5) An object designation step ST6 of designating an object (e.g., “CHARACTER AND LINE” item 281) belonging to the image IM1.

In the detection step ST1, the processing target inside portion F1 may be detected using an area (e.g., a character area AR1c and a line area AR1b) of the object (281) thus designated as the detection target area AR1.

In the above case, the detection target area AR1 can be adjusted to the intention of the user. Therefore, in the aspect described above, it is possible to improve the image quality of the print image in accordance with the intention of the user.

### Aspect 7

Incidentally, as illustrated in FIGS. 1 and 2, the printing apparatus 1 according to an aspect is the printing apparatus 1 configured to form the print image IM5 on a print medium ME0 with the ink 36, and includes the print head 30 and a control unit U1. The print head 30 is capable of ejecting the ink 36. The control unit U1 controls the ejection of the ink 36 from the print head 30 to the print medium ME0 such that the dots 38 forming the print image IM5 are formed on the print medium ME0. The control unit U1 performs the following processing as illustrated in FIGS. 3 to 7 and so on.
(b1) Detection processing (e.g., steps S102 to S104 in FIG. 3) of detecting the target pixel PX1 belonging to at least a part of the detection target area AR1 of the image IM1 as the processing target inside portion F1 when the predetermined edge inside condition (P0) that the rectangular determination area AD0 centered on the target pixel PX1 includes the surrounding area AR2 and the dark area AR3 is satisfied.
(b2) Ejection control processing (e.g., steps S106 to S114 in FIG. 3) of controlling the ejection of the ink 36 from the print head 30 to the print medium ME0 such that the amount of the ink 36 ejected to the processing target inside portion F1 is reduced to a value including 0.

In the detection processing, when the first condition (P1) that the cross area PX10 is located in the dark area AR3, the first corner pixel PX31 is located in the surrounding area AR2, and the three corner pixels PX3 excluding the first corner pixel PX31 are located in the dark area AR3 in the determination area AD0 is satisfied as the edge inside condition (P0), the control unit U1 detects the target pixel PX1 as the processing target inside portion F1. Further, in the detection processing, when the second condition (P2) that the cross area PX10 is located in the dark area AR3, the second corner pixel PX32 is located in the surrounding area AR2, and the three corner pixels PX3 excluding the second corner pixel PX32 are located in the dark area AR3 in the determination area AD0 is satisfied as the edge inside condition (P0), the control unit U1 detects the target pixel PX1 as the processing target inside portion F1.

According to the aspect described above, it is possible to provide the printing apparatus capable of suppressing the degradation of the printing quality due to the bleeding of the ink while suppressing the deterioration of the oblique edge portion in the two oblique directions. Further, the control unit U1 may perform at least a part of the color designation processing corresponding to the color designation step ST4, the edge depth designation processing corresponding to the edge depth designation step ST5, and the object designation processing corresponding to the object designation step ST6.

Further, the aspect described above can be applied to a printing method including the method of generating the dot data described above, a printing system including the printing apparatus described above, a method of controlling the printing apparatus described above, a control program of the printing apparatus described above, a non-transitory computer-readable medium on which the control program is recorded, and so on. In addition, the printing apparatus described above may be configured with a plurality of distributed portions.

### (2) Specific Example of Printing Apparatus

FIG. 1 schematically illustrates a configuration of the printing apparatus 1. The printing apparatus 1 of this specific example is the printer 2 itself, but the printing apparatus 1 may be a combination of the printer 2 and a host apparatus HO1. The host apparatus HO1 illustrated in FIG. 1 includes a display device DU1. The printer 2 illustrated in FIG. 1 is an inkjet printer that ejects the ink 36 as ink droplets 37 from the print head 30. The printer 2 may be a line printer in which the print head 30 does not move and the print medium ME0 moves in a feeding direction D3, or may be a serial printer or the like, and the printing apparatus 1 may include an additional element not illustrated in FIG. 1. FIG. 2 schematically illustrates a nozzle surface 30a of the print head 30.

The printer 2 forms the print image IM5 on the print medium ME0 with the ink 36 ejected from the print head 30. The printer 2 illustrated in FIG. 1 includes a controller 10, a random access memory (RAM) 21 that is a semiconductor memory, a communication interface (I/F) 22, a storage unit 23, an operation panel 24, the print head 30, a drive unit 50, and so on. The controller 10 and the drive unit 50 are an example of the control unit U1. The controller 10, the RAM 21, the communication I/F 22, the storage unit 23, and the operation panel 24 are coupled to a bus and can input and output information to and from each other.

The controller 10 includes a central processing unit (CPU) 11 as a processor, an edge correction unit 12, a color conversion unit 13, a halftone processing unit 14, a drive signal transmission unit 15, and so on. The controller 10 controls the drive unit 50 and the print head 30 so that the print image IM5 is formed on the print medium ME0 based on an image acquired from any of the host apparatus HO1, a memory card (not illustrated), and so on. As the image to be acquired, for example, an RGB image represented by RGB data having integer values of 2⁸ gray levels (2¹⁶ gray levels or the like) in R (red), G (green), and B (blue) for each pixel can be applied.

The controller 10 can be formed of a system on a chip (SoC) or the like.

The CPU11 is a device that mainly performs information processing and control in the printer 2.

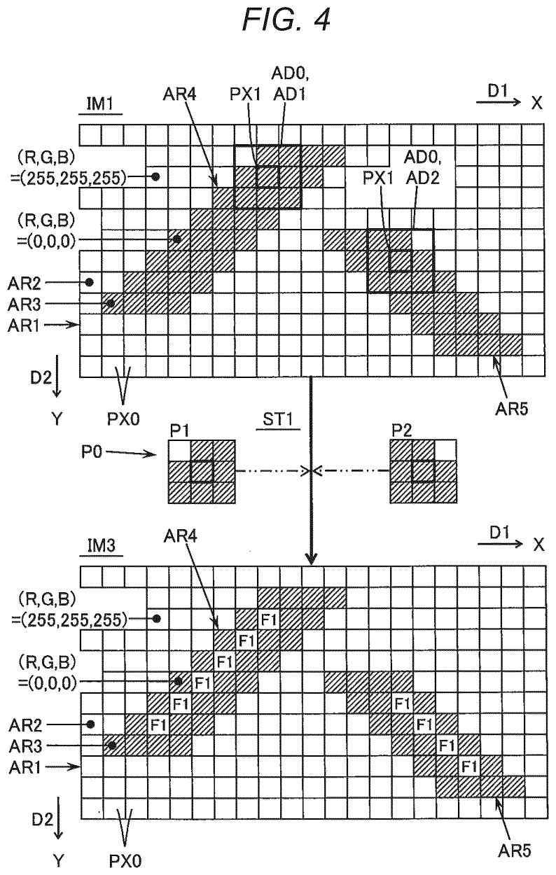

When the resolution of the acquired image is different from print resolution, the edge correction unit 12 may convert the resolution of the acquired image into the print resolution. The image resolution of which is adjusted to the print resolution is referred to as the image IM1. The edge correction unit 12 detects the processing target inside portion F1 and, as necessary, the processing target edge portion E1 in units of the pixel PX0 (see FIG. 4) from the image IM1, and generates a corrected image IM3 in which the amount of the ink 36 to be ejected to the processing target inside portion F1 and, as necessary, the processing target edge portion E1 is reduced. When the image IM1 is an RGB image, the corrected image IM3 is also an RGB image. Further, the edge correction unit 12 may generate the corrected image IM3 before the resolution conversion and then convert the resolution of the corrected image IM3 into the print resolution.

The color conversion unit 13 refers to, for example, a color conversion lookup table (LUT), in which a correspondence relationship between gradation values of R, G, and B and gradation values of C (cyan), M (magenta), Y (yellow), and K (black) is defined, to convert the RGB data representing the corrected image IM3 into ink amount data DA1. The ink amount data DA1 has, for example, integer values of 2⁸ gray levels (or 2¹⁶ gray levels) of C, M, Y, and K for each pixel PX0. The ink amount data DA1 represents the usage amount of the ink 36 of C, M, Y, and K in units of the pixel PX0.

The halftone processing unit 14 reduces the number of gray levels of the gradation value by performing halftone processing with any one of a dither method, an error diffusion method, and the like on the gradation value of each pixel PX0 constituting the ink amount data DA1 to generate the dot data DA2. The dot data DA2 represents the formation state of the dot 38 with the ink droplet 37 in units of the pixel PX0, and represents the position of the dot 38 formed with the ink 36 from the print head 30. The dot data DA2 may be binary data representing the presence or absence of dot formation, or may be multi-valued data in three or more gray levels that can cope with dots different in size such as small, medium, and large dots.

The drive signal transmission unit 15 generates a drive signal SG1 from the dot data DA2 and outputs the drive signal SG1 to the drive circuit 31 of the print head 30. The drive signal SG1 corresponds to a voltage signal applied to a drive element 32 of the print head 30. For example, when the dot data DA2 represents “dot formation”, the drive signal transmission unit 15 outputs the drive signal SG1 for ejecting the ink droplet for dot formation. Further, when the dot data DA2 is data having three or more values, the drive signal transmission unit 15 outputs the drive signal SG1 for ejecting the ink droplet for the large dot when the dot data DA2 represents “large dot formation”, and outputs the drive signal SG1 for ejecting the ink droplet for the small dot when the dot data DA2 represents “small dot formation”.

Each of the units 11 to 15 may be configured with an application specific integrated circuit (ASIC), and may directly read data to be processed from the RAM 21 or directly write processed data into the RAM 21.

As illustrated in FIG. 2, the print head 30 has, on the nozzle surface 30a, a plurality of nozzle arrays 33 in which a plurality of nozzles 34 capable of ejecting the ink droplets 37 onto the print medium ME0 is arranged at intervals of a predetermined nozzle pitch in a nozzle arrangement direction D4. Here, the nozzle means a small opening through which ink droplets are jetted, and the nozzle array means an array of a plurality of nozzles. The nozzle surface 30a is an ejection surface of the ink droplets 37. The plurality of nozzles 34 of each nozzle array 33 may be arranged in a staggered manner in the nozzle arrangement direction D4, in other words, in two rows in the nozzle arrangement direction D4. The nozzle arrangement direction D4 may cross the feeding direction D3, or may cross a main scanning direction crossing the feeding direction D3 as in a serial printer or the like. The plurality of nozzle arrays 33 includes a C nozzle array 33C capable of ejecting the ink 36 in C, an M nozzle array 33M capable of ejecting the ink 36 in M, a Y nozzle array 33Y capable of ejecting the ink 36 in Y, and a K nozzle array 33K capable of ejecting the ink 36 in K. Each ink droplet 37 is ejected from the nozzle 34 to the print medium ME0 targeting the pixel PX0. Obviously, the dot 38 in C is formed on the print medium ME0 with the ink droplet 37 in C, the dot 38 in M is formed on the print medium ME0 with the ink droplet 37 in M, the dot 38 in Y is formed on the print medium ME0 with the ink droplet 37 in Y, and the dot 38 in K is formed on the print medium ME0 with the ink droplet 37 in K. The printer 2 may include a plurality of print heads 30.

The drive unit 50 controlled by the controller 10 feeds the print medium ME0 in the feeding direction D3 along a conveyance path 59 by driving the roller driver 55. The roller driver 55 includes a conveyance roller pair 56 and a discharge roller pair 57. The roller driver 55 is configured with a servomotor, and feeds the print medium ME0 in the feeding direction D3 by rotating a driving conveyance roller of the conveyance roller pair 56 and a driving discharge roller of the discharge roller pair 57 under the control of the controller 10. It can be said that the control unit U1 controls the relative positional relationship between the print head 30 and the print medium ME0.

The print medium ME0 is a print target object that holds a print image. The material of the print medium ME0 is not particularly limited, and various materials such as paper, resin, and metal are conceivable. The shape of the print medium ME0 is also not particularly limited, and various shapes such as a rectangular shape and a roll shape are conceivable, and may be a three-dimensional shape.

A platen 58 is located below the conveyance path 59 and supports the print medium ME0 by coming into contact with the print medium ME0 located in the conveyance path 59. The print head 30 controlled by the controller 10 includes a drive circuit 31, the drive element 32, and so on, and causes the ink 36 to adhere to the print medium ME0 by ejecting the ink droplets 37 toward the print medium ME0 supported by the platen 58. Therefore, it can be said that the control unit U1 controls the ejection of the ink droplets 37 from the print head 30.

The drive circuit 31 applies a voltage signal to the drive element 32 in accordance with the drive signal SG1 input from the drive signal transmission unit 15. The drive element 32 may be a piezoelectric element that applies pressure to the ink 36 located in a pressure chamber communicating with the nozzle 34, or may be a drive element or the like that generates bubbles in the pressure chamber with heat to eject the ink droplets 37 from the nozzle 34. The ink 36 is supplied to the pressure chamber of the print head 30 from an ink supply unit 35 such as an ink cartridge or an ink tank. The ink 36 located in the pressure chamber is ejected by the drive element 32 as the ink droplets 37 from the nozzle 34 toward the print medium ME0. As a result, the dots 38 of the ink droplets 37 are formed on the print medium ME0, and the print image IM5 expressed by the pattern of the dots 38 is formed on the print medium ME0. Therefore, it can be said that the control unit U1 controls the ejection of the ink 36 from the print head 30 to the print medium ME0 such that the dots 38 constituting the print image IM5 are formed on the print medium ME0.

The RAM 21 stores images and so on received from the host apparatus HO1, a memory (not illustrated), or the like. The communication I/F 22 is coupled to the host apparatus HO1 by wire or wirelessly and inputs and outputs information to and from the host apparatus HO1. The host apparatus HO1 includes a computer such as a personal computer or a tablet terminal, a mobile phone such as a smartphone, a digital camera, a digital video camera, and so on. The storage unit 23 may be a nonvolatile semiconductor memory such as a flash memory, or may be a magnetic storage device such as a hard disk, or the like. The operation panel 24 includes an output unit 25 such as a liquid crystal panel that displays information, an input unit 26 such as a touch panel that receives an operation on a display screen, and the like.

Incidentally, it is conceivable that a dark area such as a black area surrounded by a white area becomes larger by the dot 38 derived from the ink droplet as a liquid spreading to be larger than the pixel PX0. In particular, by the ink droplets having landed on the print medium ME0 bleeding, a dark area may excessively expand to degrade the printing quality of characters or make the barcode out of the standard in some cases. Note that the dark area also includes a thin oblique line such as a glance-off portion of a small character.

Here, it is assumed that in order to prevent the degradation of the printing quality due to bleeding of ink droplets, an edge E0 of a dark area is detected and the ink droplets are not ejected over the entire edge E0.

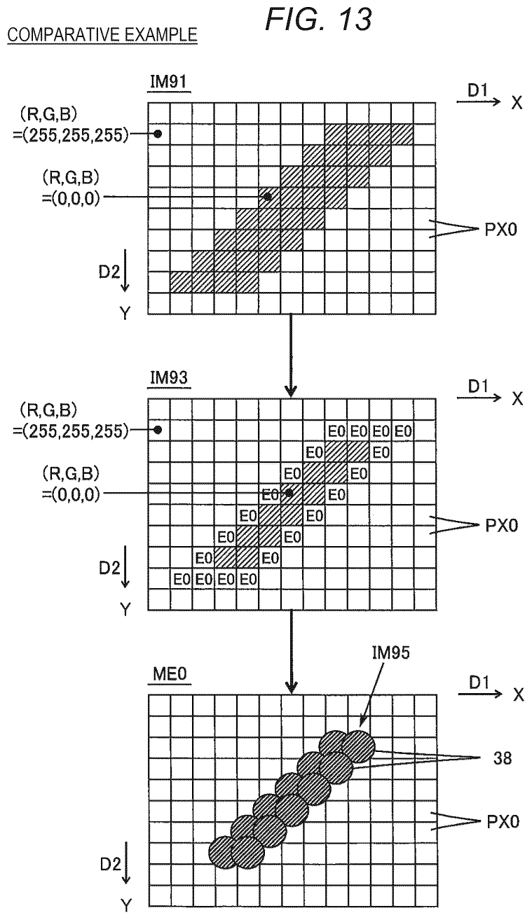

FIG. 13 schematically illustrates a comparative example in which a print image IM95 is formed from an input image IM91 as an RGB image. An upper part of FIG. 13 illustrates the input image IM91 having a black left-downward area such as a glance-off on the left of a small character, a middle part of FIG. 13 illustrates a corrected image IM93, and a lower part of FIG. 13 illustrates the print image IM95 on the print medium ME0. The images (IM91, IM93) illustrated in FIG. 13 include a plurality of pixels PX0 arranged in the X direction as an example of the first direction D1 and the Y direction as an example of the second direction D2 orthogonal to the first direction D1. In the images (IM91, IM93) illustrated in FIG. 13, the pixels PX0 located in the black area are hatched. It is assumed that the gradation values (R, G, B) of the pixel PX0 in the white area are (255, 255, 255), and the gradation values (R, G, B) of the pixel PX0 in the black area are (0, 0, 0).

The black left-downward area in the input image IM91 shown in FIG. 13 is generally an oblique line with four pixels in the X direction and the Y direction. As shown in the corrected image IM93 of FIG. 13, the edges E0 of the black area are detected from the input image IM91. When the pixel values of all the edges E0 are changed from (0, 0, 0) to (255, 255, 255), no ink droplet is ejected over the entire edges E0. As a result, the oblique line with the four pixels in the X direction and the Y direction turns to an oblique line with substantially two pixels, and the print image IM95 having the oblique line with two dots in the X direction and the Y direction is formed on the print medium ME0. Although not illustrated, an oblique line with three pixels in the X direction and the Y direction turns to an oblique line with substantially one pixel. Therefore, the oblique line becomes too thin, and deterioration of the object including the oblique line becomes conspicuous. Further, the same applies to when the input image IM91 includes a black right-downward area such as a glance-off on the right of a small character.

In the present specific example, there is adopted a rule that an amount of the ink 36 ejected to a portion slightly inner side of the edge portion along one of the two oblique directions is reduced. Accordingly, there is adopted a rule that the disadvantage that the oblique edge portion of the object such as a thin oblique line including a glance-off portion of a small character becomes too thin is avoided while obtaining the effect of suppressing the degradation of the printing quality due to bleeding of the ink 36.

A specific example of print control processing for implementing the method of generating the dot data will hereinafter be described with reference to FIGS. 3 to 12B.

### (3) Specific Example of Print Control Processing

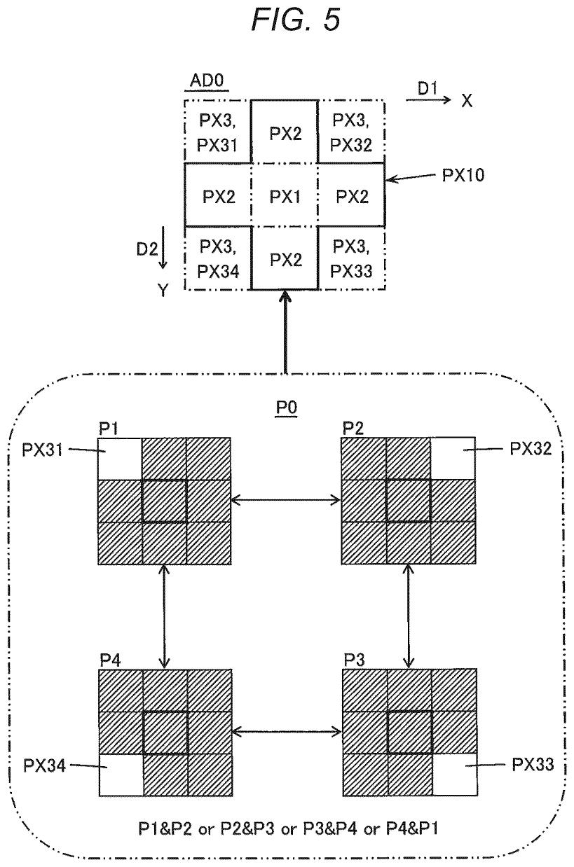

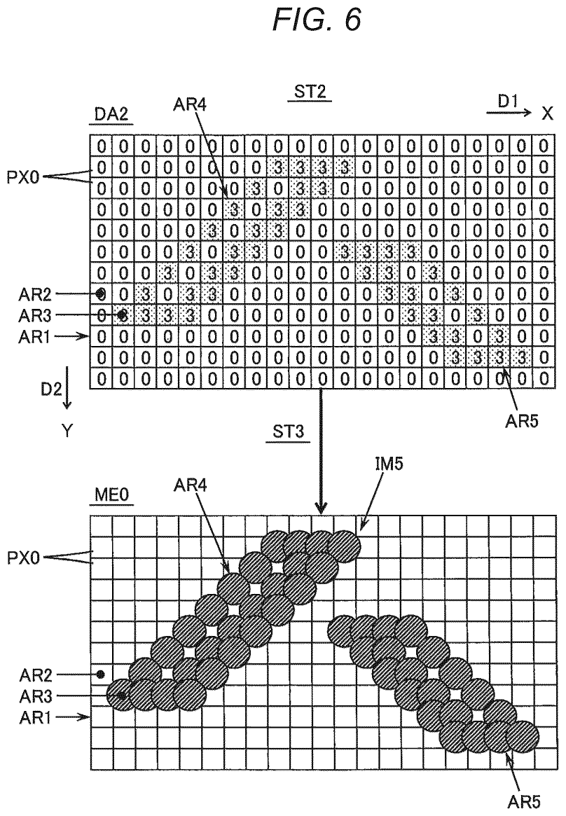

FIG. 3 schematically illustrates the print control processing performed by the controller 10. FIG. 4 schematically illustrates a state in which the corrected image IM3 in which the amount of the ink in the processing target inside portion F1 is reduced is generated from the input image. It is assumed that the input image is an RGB image, and the images (IM1, IM3) shown in FIG. 4 are each an RGB image. In the images (IM1, IM3) shown in FIG. 4, the surrounding area AR2 is a white area in which the pixel values (R, G, B) are (255, 255, 255), and the dark area AR3 darker than the surrounding area AR2 is a black area in which the pixel values (R, G, B) are (0, 0, 0). FIG. 4 also shows a reference pattern P0 applied to the image IM1. FIG. 5 schematically illustrates an example in which individual reference patterns are combined. In FIGS. 4 and 5, pixels PX0 located in the dark area AR3 including the reference pattern P0 are hatched. FIG. 6 schematically illustrates a state in which the print image IM5 is formed from the dot data DA2.

In FIG. 3, steps S102 to S104 correspond to the detection step ST1 and the detection processing. Steps S106 to S112 correspond to the generation step ST2. Step S114 corresponds to the printing step ST3. Steps S108 to S114 correspond to the ejection control processing. Hereinafter, the description of “step” may be omitted, and the reference character of the step may be shown in a parenthesis.

When the print control processing shown in FIG. 3 starts, the controller 10 performs, in the edge correction unit 12, detection processing of detecting the processing target inside portion F1 in an oblique direction from the image IM1 which is an RGB image (S102).

It is assumed that the image IM1 includes a plurality of pixels PX0 arranged in the X direction as an example of the first direction D1 and the Y direction as an example of the second direction D2 crossing the first direction D1 as illustrated in FIG. 4. The feeding direction D3 illustrated in FIGS. 1 and 2 may be the X direction or may be the Y direction. In FIG. 4, the X direction and the Y direction are orthogonal to each other. Note that the Y direction may be assumed as the first direction D1, and the X direction may be assumed as the second direction D2. In FIG. 4, the detection target area AR1 of the processing target inside portion F1 is the whole of the image IM1. Note that as shown in the corrected image IM3 illustrated in FIG. 8, the edge E0 existing in the detection target area AR1 is assumed as an area corresponding to one pixel adjacent to the surrounding area AR2 in the X direction or the Y direction in the dark area AR3.

The image IM1 shown in FIG. 4 includes, as the dark area AR3, a black left-downward area AR4 such as a glance-off on the left of a character and a black right-downward area AR5 such as a glance-off on the right of a character. In the present specific example, it is assumed that the processing target inside portion F1 is detected from these areas (AR4 and AR5). The processing target inside portion F1 can be detected by pattern matching using the reference pattern P0 shown in FIGS. 4 and 5. Here, the pattern means a set of features such as signals and pictures, and a relationship between the features. The pattern matching means to compare a certain pattern and a plurality of patterns prepared in advance with each other based on a predetermined evaluation criterion. The pattern matching is not limited to a comparison between an image and an image as long as the state of a target pixel and the surrounding pixels can be compared between an image and a pattern based on an evaluation criterion such as a comparison between signals expressed by 0 and 1. The reference pattern P0 shown in FIG. 5 is a combination of two reference patterns selected from individual reference patterns P1 to P4, and can be said to be a teacher image of the image IM1. FIG. 4 shows that the reference pattern P0 is a combination of the individual reference patterns P1, P2. The reference patterns P1 to P4 have a rectangular shape (including a square shape). The reference patterns P1 to P4 shown in FIGS. 4 and 5 have a square shape of 3×3 pixels. For the sake of convenience of explanation, the pixel PX0 belonging to the surrounding area AR2 is referred to as a light pixel, and the pixel PX0 belonging to the dark area AR3 is referred to as a dark pixel. The light pixels shown in FIGS. 4 and 5 are white pixels pixel values (R, G, B) of which are (255, 255, 255), and the pixel values of the light pixels in the reference patterns P1 to P4 also satisfy (R, G, B)=(255, 255, 255). The dark pixels shown in FIGS. 4 and 5 are black pixels pixel values (R, G, B) of which are (0, 0, 0), and the pixel values of the dark pixels in the reference patterns P1 to P4 also satisfy (R, G, B)=(0, 0, 0).

Note that the size of the reference pattern may be 5×5 pixels, or may be a non-square size such as 3×5 pixels or 5×3 pixels.

The controller 10 sequentially sets the target pixel PX1 out of the plurality of pixels PX0 belonging to the image IM1, and performs pattern matching in which the reference pattern P0 is applied to the rectangular determination area AD0 centered on the target pixel PX1. The determination area AD0 has the same size as the reference patterns P1 to P4, and is an area of 3×3 pixels centered on the target pixel PX1 in the example illustrated in FIG. 4. When the arrangement of the light pixels and the dark pixels in the determination area AD0 matches the arrangement of the light pixels and the dark pixels in one of the individual reference patterns P1, P2, the controller 10 detects the target pixel PX1 as the processing target inside portion F1. When the pixel arrangement of the determination area AD0 does not match any of the pixel arrangements of the reference patterns P1, P2, the target pixel PX1 is not the processing target inside portion F1. In FIG. 4, the reference pattern P1 has a pixel arrangement for detecting the processing target inside portion F1 along the upper left edge of the left-downward area AR4, and the reference pattern P2 has a pixel arrangement for detecting the processing target inside portion F1 along the upper right edge of the right-downward area AR5. The pixel arrangement of the reference pattern P1 is an example of the first condition as the edge inside condition, and the pixel arrangement of the reference pattern P2 is an example of the second condition as the edge inside condition.

For example, since the pixel arrangement of the determination area AD1 matches the pixel arrangement of the reference pattern P1, the target pixel PX1 in the determination area AD1 is detected as the processing target inside portion F1. Since the pixel arrangement of the determination area AD2 matches the pixel arrangement of the reference pattern P2, the target pixel PX1 in the determination area AD2 is detected as the processing target inside portion F1.

In this way, the controller 10 detects the target pixel PX1 as the processing target inside portion F1 when the rectangular determination area AD0 centered on the target pixel PX1 belonging to the detection target area AR1 satisfies the predetermined edge inside condition including the surrounding area AR2 and the dark area AR3.

Here, with reference to FIG. 5, each pixel PX0 belonging to the determination area AD0 of 3×3 pixels is selectively referred to as follows.

The pixel PX0 located at the center of the determination area AD0 is the target pixel PX1. In the determination area AD0, the pixels PX0 adjacent to the target pixel PX1 in the first direction D1 and the second direction D2 are referred to as adjacent pixels PX2. The target pixel PX1 and the four adjacent pixels PX2 form a cross shape. Therefore, in the determination area AD0, the target pixel PX1 and the four adjacent pixels PX2 are referred to as the cross area PX10. The pixels PX0 at the four corners of the determination area AD0 are referred to as corner pixels PX3. Therefore, the determination area AD0 includes the cross area PX10 and the corner pixels PX3 located at the four corners. The four corner pixels PX3 include a first corner pixel PX31, a second corner pixel PX32, a third corner pixel PX33, and a fourth corner pixel PX34. Although the positions of these corner pixels (PX31 to PX34) are relative, it is assumed that the second corner pixel PX32 is not located at a diagonal position from the first corner pixel PX31 in the determination area AD0. FIG. 5 shows that the first corner pixel PX31 is located at the upper left in the determination area AD0, the second corner pixel PX32 is located at the upper right in the determination area AD0, the third corner pixel PX33 is located at the lower right in the determination area AD0, and the fourth corner pixel PX34 is located at the lower left in the determination area AD0. When the first corner pixel PX31 is located at the upper left in the determination area AD0, the second corner pixel PX32 may be located at the lower left in the determination area AD0. Obviously, the first corner pixel PX31 may be located at the upper right in the determination area AD0, may be located at the lower right in the determination area AD0, or may be located at the lower left in the determination area AD0.

As the reference pattern P0 for detecting the processing target inside portion F1, the four reference patterns P1 to P4 illustrated in FIG. 5 are conceivable. The reference pattern P1 has an arrangement in which the first corner pixel PX31 is a light pixel and the remaining eight pixels are dark pixels. The reference pattern P2 has an arrangement in which the second corner pixel PX32 is a light pixel and the remaining eight pixels are dark pixels. The reference pattern P3 has an arrangement in which the third corner pixel PX33 is a light pixel and the remaining eight pixels are dark pixels. The reference pattern P4 has an arrangement in which the fourth corner pixel PX34 is a light pixel and the remaining eight pixels are dark pixels. Out of the reference patterns P1 to P4, the reference patterns P1, P3 have a pixel arrangement for detecting the processing target inside portion F1 of the left-downward area AR4, and the reference patterns P2, P4 have a pixel arrangement for detecting the processing target inside portion F1 of the right-downward area AR5. By combining either one of the reference patterns P1, P3 and either one of the reference patterns P2, P4, the amount of the ink in the processing target inside portion F1 can be reduced in both the left-downward area AR4 and the right-downward area AR5. In the present specific example, in order to prevent the amount of the ink inside the oblique line from being excessively reduced in the print image IM5, there is adopted a rule that either one of the reference patterns P1, P3 is used for the left-downward area AR4, and either one of the reference patterns P2, P4 is used for the right-downward area AR5. That is, the reference pattern P1 and the reference pattern P3 are not combined, and the reference pattern P2 and the reference pattern P4 are not combined. FIG. 4 shows that a combination of the reference patterns P1, P2 is used as the reference pattern P0. The reference pattern P0 may be a combination of the reference patterns P1, P4, may be a combination of the reference patterns P3, P2, or may be a combination of the reference patterns P3, P4.

First, there will be described when the reference pattern P0 is the combination of the reference patterns P1, P2 as shown in FIG. 4.

The determination area AD0 matching the reference pattern P1 means that the cross area PX10 is in the dark area AR3, the first corner pixel PX31 is in the surrounding area AR2, and the three corner pixels PX3 other than the first corner pixel PX31 are in the dark area AR3. The determination area AD0 matches the reference pattern P1 when the pixel is located at an inner side by one pixel from the upper left edge in the left-downward area AR4. Here, a condition that the determination area AD0 matches the reference pattern P1 is referred to as a first condition. When the determination area AD0 satisfies the first condition, the controller 10 detects the target pixel PX1 as the processing target inside portion F1.

The determination area AD0 matching the reference pattern P2 means that the cross area PX10 is in the dark area AR3, the second corner pixel PX32 is in the surrounding area AR2, and the three corner pixels PX3 other than the second corner pixel PX32 are in the dark area AR3. The determination area AD0 matches the reference pattern P1 when the pixel is located at an inner side by one pixel from the upper right edge in the right-downward area AR5. Here, a condition that the determination area AD0 matches the reference pattern P2 is referred to as a second condition. When the determination area AD0 satisfies the second condition, the controller 10 detects the target pixel PX1 as the processing target inside portion F1.

After detecting the processing target inside portion F1, the controller 10 performs, in the edge correction unit 12, detection processing of detecting a part of the edge E0 from the image IM1 as the processing target edge portion E1 as needed (S104). The processing in S104 will be described later in detail.

In S106, the controller 10 performs, in the edge correction unit 12, the correction of reducing the ink amount in the processing target inside portion F1. As a result, it can be said that the processing in S106 is processing of thinning or reducing the size of the dots 38 of the processing target inside portion F1. In the example shown in FIGS. 4 and 6, the controller 10 generates the dot data DA2 from the image IM1 so that the ink 36 is not ejected from the print head 30 to the processing target inside portion F1. For example, the controller 10 generates the corrected image IM3 by changing the pixel values (R, G, B) of the processing target inside portion F1 out of the image IM1 from (0, 0, 0) to (255, 255, 255). Note that the ink amount of the processing target inside portion F1 may be reduced to, for example, 1 to 50 % with reference to that before the correction. For example, the pixel values (R, G, B) of the processing target inside portion F1 may be replaced with (128, 128, 128) which are each an ink amount of about 50 % with reference to that before the correction. Note that the pixel values shown in the present specification are merely examples for explaining the present specific example in an easy-to-understand manner, and can variously be changed. The same applies to the following.

When the processing target edge portion E1 is detected, the controller 10 performs, in the edge correction unit 12, the correction of reducing the ink amount in the processing target edge portion E1 (S108). Details of S108 will be described later.

In S110, the controller 10 performs, in the color conversion unit 13, color conversion processing of converting the corrected image IM3 into the ink amount data DA1. When the pixel values (R, G, B) of the corrected image IM3, which is an RGB image, are (255, 255, 255), the pixel values of the pixel PX0 of the processing target inside portion F1 are converted into pixel values with which the ink droplet 37 is not ejected, such as (C, M, Y, K)=(0, 0, 0, 0). After the color conversion processing, the controller 10 performs, in the halftone processing unit 14, halftone processing of converting the ink amount data DA1 into the dot data DA2 (S112). When the pixel values (C, M, Y, K) of the ink amount data DA1 are (0, 0, 0, 0), the pixel values of the pixel PX0 of the processing target inside portion F1 are converted into a value representing absence of the dot such as 0 in all of C, M, Y, and K. The dot data DA2 for forming the dots 38 such as large dots in the dark pixels of the corrected image IM3 is schematically illustrated in the print medium ME0 shown in FIG. 6. In order to present an easy-to-understand illustration, in the print medium ME0 shown in FIG. 6, small blanks are shown in the processing target inside portion F1, but when the ink droplets 37 bleed, the blanks are not visually recognized.

In this way, the controller 10 generates the dot data DA2 from the image IM1 so that the amount of the ink 36 to be ejected from the print head 30 to the processing target inside portion F1 is reduced to a value including 0. Note that in the present specification, “so that the amount of the ink 36 to be ejected to the processing target inside portion F1 is reduced to a value including 0” is intended “to reduce the amount of the ink to be ejected” with reference to when the correction is not performed as described above in S106, or “to stop the ejection”.

After the halftone processing, the controller 10 generates the drive signal SG1 based on the dot data DA2, and then transmits the drive signal SG1 to the drive circuit 31 of the print head 30 (S114), to end the print control processing. The print head 30 ejects the ink droplets 37 in K so that a plurality of dots 38 is formed in the dark pixels as illustrated in the print medium ME0 in FIG. 6 in accordance with the drive signal SG1. As a result, the print image IM5 expressed by the pattern of the dots 38 is formed on the print medium ME0. It can be said that the printer 2 ejects the ink 36 from the print head 30 onto the print medium ME0 based on the dot data DA2.

As described above, the amount of the ink 36 ejected to the portion slightly inner side of the edge portion along either one of the two oblique directions is reduced. Accordingly, it is possible to avoid the disadvantage that the oblique edge portion of the object such as a thin oblique line including a glance-off portion of a small character becomes too thin while obtaining the effect of suppressing the degradation of the printing quality due to bleeding of the ink 36.

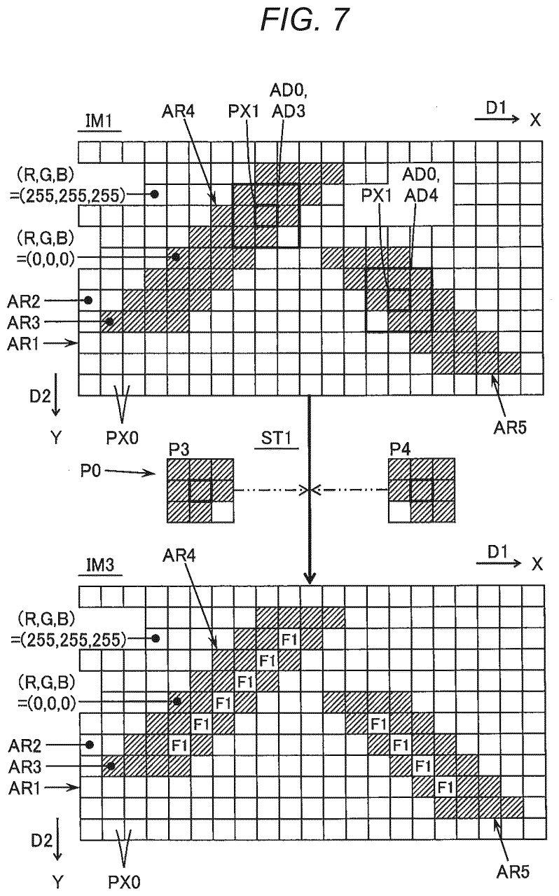

Then, there will be described when the reference pattern P0 is the combination of the reference patterns P3, P4 as shown in FIG. 7. FIG. 7 schematically illustrates another example of generating, from the input image, the corrected image IM3 in which the amount of the ink in the processing target inside portion F1 is reduced. In the example illustrated in FIG. 7, in the determination area AD0 illustrated in FIG. 5, it is read that the first corner pixel PX31 is located at the position of the third corner pixel PX33 and the second corner pixel PX32 is located at the position of the fourth corner pixel PX34.

The determination area AD0 matches the reference pattern P3 when the pixel is located at an inner side by one pixel from the lower right edge in the left-downward area AR4. The condition that the determination area AD0 matches the reference pattern P3 is an example of the first condition. When the determination area AD0 satisfies the first condition, the controller 10 detects the target pixel PX1 as the processing target inside portion F1. For example, since the pixel arrangement of the determination area AD3 matches the pixel arrangement of the reference pattern P3, the target pixel PX1 in the determination area AD3 is detected as the processing target inside portion F1. Further, the determination area AD0 matches the reference pattern P4 when the pixel is located at an inner side by one pixel from the lower left edge in the right-downward area AR5. The condition that the determination area AD0 matches the reference pattern P2 is an example of the second condition. When the determination area AD0 satisfies the second condition, the controller 10 detects the target pixel PX1 as the processing target inside portion F1. For example, since the pixel arrangement of the determination area AD4 matches the pixel arrangement of the reference pattern P4, the target pixel PX1 in the determination area AD4 is detected as the processing target inside portion F1.

In S106, the controller 10 performs, in the edge correction unit 12, the correction of reducing the ink amount in the processing target inside portion F1. Subsequently, by performing the processing in S110 to S114, the dot data DA2 is generated from the image IM1 such that the amount of the ink 36 to be ejected from the print head 30 to the processing target inside portion F1 is reduced to a value including 0, and the print image IM5 is formed.

Also in this case, it becomes possible to avoid the disadvantage that the oblique edge portion of the object such as a thin oblique line becomes too thin while obtaining the effect of suppressing the degradation of the printing quality due to the bleeding of the ink 36.

Incidentally, it is conceivable that a dark area excessively expands due to the bleeding of the edge portion along the X direction or the Y direction to degrade the printing quality of a character or to make a barcode out of a standard. For example, when a black line in which three pixels are arranged in the X direction is directed toward the Y direction, when the ink droplets are not ejected over the entire edge E0 in the black area in order to prevent degradation of printing quality due to the bleeding of the ink droplets, the width of the black line decreases from three pixels to one pixel. When the black line is a barcode, the barcode may become too thin to read in some cases. When the black line is an object including a thin line such as a character, the deterioration of the object is conspicuous.

In the present specific example, in the processing in S104 and S108 illustrated in FIG. 3, it is possible to suppress the degradation of the printing quality due to the bleeding of the ink while suppressing the deterioration of the thin line by limiting the edge portion where the ink amount is reduced to a part of the edge portion.

FIG. 8 schematically illustrates a state of forming the print image IM5 in which the ink amount of the processing target edge portion E1 is reduced from the input image.

In S104 illustrated in FIG. 3, the controller 10 performs, in the edge correction unit 12, the detection processing of detecting a part of the edge E0 from the image IM1 which is an RGB image as the processing target edge portion E1.

Here, out of the edge portions located at the left side and the right side of the dark area AR3 in the X direction, the edge portion located at one side is defined as a first edge portion E11. Further, out of the edge portions located at the upper side and the lower side of the dark area AR3 in the Y direction, the edge portion located at one side is defined as a second edge portion E12. FIG. 8 shows that the first edge portion E11 is located at the right side in the dark area AR3 and the second edge portion E12 is located at the lower side in the dark area AR3. The first edge portion E11 may be located at the left side instead of the right side in the dark area AR3. That is, the first edge portions E11 do not exist at both sides of the dark area AR3 in the X direction. The second edge portion E12 may be located at the upper side instead of the lower side in the dark area AR3. That is, the second edge portions E12 do not exist at both sides of the dark area AR3 in the Y direction.

FIG. 8 illustrates that both the first edge portion E11 and the second edge portion E12 are detected as the processing target edge portion E1. The controller 10 may detect the first edge portion E11 as the processing target edge portion E1 without including the second edge portion E12, or may detect the second edge portion E12 as the processing target edge portion E1 without including the first edge portion E11. When an area is longer in the Y direction than in the X direction as in the case of the dark area AR3 shown in FIG. 8, the processing target edge portion E1 preferably includes the first edge portion E11.

The processing target edge portion E1 can be detected by pattern matching using the reference pattern P10 shown in FIG. 8. The reference pattern P10 is a collective term of the rectangular reference patterns P11 to P15, and can also be referred to as a teacher image of the image IM1. The reference patterns P11 to P15 illustrated in FIG. 8 each have a square shape of 3×3 pixels. The light pixels shown in FIG. 8 are white pixels having the pixel values (R, G, B) of (255, 255, 255) including the inside of the reference pattern P10, and the dark pixels shown in FIG. 8 are black pixels having the pixel values (R, G, B) of (0, 0, 0) including the inside of the reference pattern P10.

Also in this case, the size of the reference pattern may be 5×5 pixels, or may be a size other than a square shape such as 3×5 pixels or 5×3 pixels.

The controller 10 sequentially sets the target pixel PX1 out of the plurality of pixels PX0 belonging to the image IM1, and performs pattern matching in which the reference pattern P10 is applied to the rectangular determination area AD0 centered on the target pixel PX1. The determination area AD0 has the same size as the reference patterns P11 to P15, and is an area of 3×3 pixels centered on the target pixel PX1 in the example illustrated in FIG. 8. When the arrangement of the light pixels and the dark pixels in the determination area AD0 matches the arrangement of the light pixels and the dark pixels in one of the reference patterns P11 to P15, the controller 10 detects the target pixel PX1 as the processing target edge portion E1. When the pixel arrangement of the determination area AD0 does not match any of the pixel arrangements of the reference patterns P11 to P15, the target pixel PX1 is not the processing target edge portion E1. For example, since the pixel arrangement of the determination area AD5 matches the pixel arrangement of the reference pattern P11, the target pixel PX1 in the determination area AD5 is detected as the processing target edge portion E1. Since the pixel arrangement of the determination area AD6 matches the pixel arrangement of the reference pattern P12, the target pixel PX1 in the determination area AD6 is detected as the processing target edge portion E1.

In this way, the controller 10 detects, as the processing target edge portion E1, at least one of the first edge portion E11 located at one side in the dark area AR3 in the first direction D1 and the second edge portion E12 located at one side in the dark area AR3 in the second direction D2 out of the edges E0 existing in the detection target area AR1.

In S108 shown in FIG. 3, the controller 10 performs, in the edge correction unit 12, correction for reducing the ink amount in the processing target edge portion E1. As a result, it can be said that the processing in S108 is processing of thinning or reducing the size of the dots 38 of the processing target edge portion E1. In the example shown in FIG. 8, the controller 10 generates the dot data DA2 from the image IM1 so that the ink 36 is not ejected from the print head 30 to the processing target edge portion E1. For example, the controller 10 generates the corrected image IM3 by changing the pixel values (R, G, B) of the processing target edge portion E1 out of the image IM1 from (0, 0, 0) to (255, 255, 255). Note that the ink amount of the processing target edge portion E1 may be reduced to, for example, 1 to 50 % with reference to that before the correction. For example, the pixel values (R, G, B) of the processing target edge portion E1 may be replaced with (128, 128, 128) which are each an ink amount of about 50 % with reference to that before the correction.

After the processing in S108, the controller 10 performs, in the color conversion unit 13, color conversion processing of converting the corrected image IM3 into the ink amount data DA1 (S110). When the pixel values (R, G, B) of the corrected image IM3, which is an RGB image, are (255, 255, 255), the pixel values of the pixel PX0 of the processing target edge portion E1 are converted into pixel values with which the ink droplet 37 is not ejected, such as (C, M, Y, K)=(0, 0, 0, 0). After the color conversion processing, the controller 10 performs, in the halftone processing unit 14, halftone processing of converting the ink amount data DA1 into the dot data DA2 (S112). When the pixel values (C, M, Y, K) of the ink amount data DA1 are (0, 0, 0, 0), the pixel values of the pixel PX0 of the processing target edge portion E1 are converted into a value representing absence of the dot such as 0 in all of C, M, Y, and K. The dot data DA2 for forming the dots 38 such as large dots in the dark pixels of the corrected image IM3 is schematically illustrated in the print medium ME0 shown in FIG. 8.

By performing the processing in S102 to S112 illustrated in FIG. 3, the dot data DA2 is generated from the image IM1 such that the amount of the ink 36 ejected from the print head 30 to the processing target inside portion F1 and the processing target edge portion E1 is reduced to a value including 0. By performing the processing in S114 illustrated in FIG. 3, the print image IM5 in which the ink amount of the processing target inside portion F1 and the processing target edge portion E1 is reduced is formed.

By performing the processing in S104 and S108 illustrated in FIG. 3, the amount of the ink 36 ejected not to the whole of the edge E0 existing in the detection target area AR1 but to at least one of the edge portions (E11 and E12) located at one sides in the dark area AR3 is reduced. Accordingly, it becomes possible to avoid the disadvantage that an object such as a barcode or a fine character becomes too thin while obtaining an effect of suppressing the degradation of the printing quality due to the bleeding of the ink 36. On that basis, it becomes possible to avoid the disadvantage that an oblique edge portion of an object such as a thin oblique line becomes too thin.

Note that as illustrated in FIG. 9, a small amount of ink 36 may be ejected from the print head 30 to the processing target inside portion F1 in order to prevent the blank (see FIG. 6) from being visually recognized at the portion corresponding to the processing target inside portion F1 in the print image IM5. FIG. 9 schematically illustrates another example of forming the print image IM5 from the dot data DA2.

In S106 illustrated in FIG. 3, the controller 10 performs, in the edge correction unit 12, the correction of reducing the ink amount in the processing target inside portion F1 to, for example, 1 to 50 % of the amount before the correction. For example, the pixel values (R, G, B) of the processing target inside portion F1 may be replaced with (64, 64, 64) which are each an ink amount of about 25 % with reference to that before the correction.

In S108 shown in FIG. 3, the controller 10 performs, in the edge correction unit 12, correction of making the ink amount in the processing target edge portion E1 smaller than the ink amount in the processing target inside portion F1. For example, as shown in FIG. 8, the controller 10 generates the corrected image IM3 by changing the pixel values (R, G, B) of the processing target edge portion E1 out of the image IM1 from (0, 0, 0) to (255, 255, 255).

In S110, the color conversion processing of converting the corrected image IM3 into the ink amount data DA1 is performed in the color conversion unit 13. When the pixel values (R, G, B) of the corrected image IM3, which is an RGB image, are (255, 255, 255), the pixel values of the pixel PX0 of the processing target edge portion E1 are converted into pixel values with which the ink droplet 37 is not ejected, such as (C, M, Y, K)=(0, 0, 0, 0). When the pixel values (R, G, B) of the corrected image IM3 are (64, 64, 64), the pixel values of the pixel PX0 of the processing target inside portion F1 are converted from the pixel values with which the size of the ink droplet 37 in K corresponds to a large dot into the pixel values with which the size of the ink droplet 37 in K is reduced to a size corresponding to a small dot, for example, (C, M, Y, K)=(0, 0, 0, 63). After the color conversion processing, the controller 10 performs, in the halftone processing unit 14, halftone processing of converting the ink amount data DA1 into the dot data DA2 (S112). When the pixel values (C, M, Y, K) of the ink amount data DA1 are (0, 0, 0, 0), the pixel values of the pixel PX0 of the processing target edge portion E1 are converted into a value representing absence of the dot such as 0 in all of C, M, Y, and K. When the pixel values (C, M, Y, K) of the ink amount data DA1 is (0, 0, 0, 64), the pixel values of the pixel PX0 of the processing target inside portion F1 are converted so that the pixel value for K represents a small dot, for example, 1. After the halftone processing, the print image IM5 is formed on the print medium ME0 (S114).

In the example shown in FIGS. 8 and 9, the controller 10 makes the amount of the ink 36 ejected from the print head 30 to the processing target edge portion E1 smaller than the amount of the ink 36 ejected from the print head 30 to the processing target inside portion F1. Since the amount of the ink to be ejected to the processing target edge portion E1 is smaller than the amount of the ink to be ejected to the processing target inside portion F1, the ink 36 is prevented from bleeding so as to spread from the edge portion. In particular, when the ink 36 is not ejected from the print head 30 to the processing target edge portion E1, the ink 36 is effectively prevented from bleeding so as to spread from the edge portion. Therefore, it is possible to further suppress the degradation of the printing quality of an object such as a barcode or a fine character due to the bleeding of the ink 36.

Note that a part of the processing described above may be performed by the host apparatus HO1. In this case, a combination of the controller 10, the drive unit 50, and the host apparatus HO1 is an example of the control unit U1, and a combination of the printer 2 and the host apparatus HO1 is an example of the printing apparatus 1. The subject that performs the processing described above is not limited to the CPU, and may be an electronic component other than the CPU, such as an ASIC. Obviously, a plurality of CPUs may cooperate with each other to perform the processing described above, or the CPU and other electronic components (e.g., an ASIC) may cooperate with each other to perform the processing described above.

In order to set the amount of the ink 36 to be ejected to the processing target inside portion F1, the printing apparatus 1 is capable of displaying an inside ink amount designation screen 520 illustrated in FIG. 10A on at least one of the output unit 25 of the operation panel 24 and the display device DU1 of the host apparatus HO1. FIG. 10A schematically illustrates a display example of the inside ink amount designation screen 520.

The inside ink amount designation screen 520 illustrated in FIG. 10A includes a “NO INK EJECTION” item 221, a “SMALL INK EJECTION” item 222, and so on. The “NO INK EJECTION” item 221 is an option in which the ink droplet 37 is not ejected to the processing target inside portion F1. The “SMALL INK EJECTION” item 222 is an option for ejecting the ink droplet 37 corresponding to the small dot to the processing target inside portion F1. For example, the controller 10 makes the output unit 25 display the inside ink amount designation screen 520, and then receives designation of any one of the plurality of options (221, 222) in the input unit 26 of the operation panel 24. When the designation of the “NO INK EJECTION” item 221 is received, the controller 10 generates the corrected image IM3 by replacing, in S106 illustrated in FIG. 3, the pixel values (R, G, B) of the processing target inside portion F1 with (255, 255, 255). As a result, as shown in FIG. 6, the dots 38 are not formed in the processing target inside portion F1. When the designation of the “SMALL INK EJECTION” item 222 is received, the controller 10 generates the corrected image IM3 by replacing, in S106 shown in FIG. 3, the pixel values (R, G, B) of the processing target inside portion F1 with (64, 64, 64). As a result, as shown in FIG. 9, the small dots are formed in the processing target inside portion F1. Obviously, the host apparatus HO1 may cause the display device DU1 to display the inside ink amount designation screen 520, and then receive, in an input unit (not illustrated), designation of any one of the plurality of options (221, 222).

In this way, when the “NO INK EJECTION” item 221 is designated, the printing apparatus 1 generates the dot data DA2 from the image IM1 so that the ink 36 is not ejected from the print head 30 to the processing target inside portion F1. When the “SMALL INK EJECTION” item 222 is designated, the printing apparatus 1 generates the dot data DA2 from the image IM1 so that the amount of the ink 36 ejected from the print head 30 to the processing target inside portion F1 is reduced within a range in which the amount is not zero.

Further, in order to switch the definition of the dark area AR3 in the print control processing illustrated in FIG. 3, the printing apparatus 1 can display a dark area designation screen 540 illustrated in FIG. 10B on at least one of the output unit 25 of the operation panel 24 and the display device DU1 of the host apparatus HO1. FIG. 10B schematically illustrates a display example of the dark area designation screen 540.

The dark area designation screen 540 illustrated in FIG. 10B includes a plurality of options 240 to be applied to the dark area AR3, such as a “BLACK ONLY” item 241 and an “OTHER THAN WHITE” item 242. The “BLACK ONLY” item 241 is an option for applying black of (R, G, B)=(0, 0, 0) as an example of the predetermined color to the dark area AR3. The “OTHER THAN WHITE” item 242 is an option for applying a color range other than white as an example of a predetermined color range to the dark area AR3. For example, the controller 10 makes the output unit 25 display the dark area designation screen 540, and then receives designation of any one of the plurality of options (241, 242) in the input unit 26 of the operation panel 24. When the designation of the “BLACK ONLY” item 241 is received, the controller 10 applies black with the pixel values (R, G, B)=(0, 0, 0) to the dark area AR3 in the images (IM1, IM3) and the reference patterns P0, P10 to perform the print control processing of FIG. 3. When the designation of the “OTHER THAN WHITE” item 242 is received, the controller 10 applies all colors whose pixel values (R, G, B) are not (255, 255, 255) to the dark area AR3 in the images (IM1, IM3) and the reference patterns P0, P10 to perform the print control processing of FIG. 3. Obviously, the host apparatus HO1 may cause the display device DU1 to display the dark area designation screen 540, and then receive, in the input unit (not illustrated), designation of any one of the plurality of options 240. In any case, the color designation step ST4 of receiving designation of an option to be applied to the dark area AR3 out of the plurality of options 240 including the “BLACK ONLY” item 241 and the “OTHER THAN WHITE” item 242 is performed.

When the “BLACK ONLY” item 241 is designated, the printing apparatus 1 treats the pixel PX0 having the pixel values (R, G, B)=(0, 0, 0) as the dark area AR3 in the images (IM1, IM3) and the reference patterns P0, P10 to perform the print control processing shown in FIG. 3. For example, the controller 10 detects, as the processing target inside portion F1, the target pixel PX1 having the arrangement of the surrounding area AR2 with the pixel values (R, G, B)=(255, 255, 255) and the dark area AR3 with the pixel values (R, G, B)=(0, 0, 0) matching the arrangement of any one of the reference patterns P1, P2 in the image IM1. It can be said that when the predetermined color is designated, the control unit U1 detects the target pixel PX1 as the processing target inside portion F1 when the distribution of the dark area AR3 having the predetermined color and the surrounding area AR2 satisfies the edge inside condition in the determination area AD0. The same applies to the processing target edge portion E1.

When the “OTHER THAN WHITE” item 242 is designated, the printing apparatus 1 treats the pixel PX0 having the pixel values (R, G, B) other than (255, 255, 255) as the dark area AR3 to perform the print control processing shown in FIG. 3. For example, the controller 10 detects, as the processing target inside portion F1, the target pixel PX1 having the arrangement of the surrounding area AR2 with the pixel values (R, G, B)=(255, 255, 255) and the dark area AR3 with the pixel values other than (R, G, B)=(255, 255, 255) matching the arrangement of any one of the reference patterns P1, P2 in the image IM1. It can be said that when the predetermined color range is designated, the control unit U1 detects the target pixel PX1 as the processing target inside portion F1 when the distribution of the dark area AR3 in the predetermined color range and the surrounding area AR2 satisfies the edge inside condition in the determination area AD0. The same applies to the processing target edge portion E1.

For example, when an object such as a thin oblique line or a barcode is black and the “BLACK ONLY” item 241 is designated, a high-quality print image IM5 is obtained by reducing the ink amount in the processing target inside portion F1 and the processing target edge portion E1 with respect to the black object. For example, it is assumed that it is difficult to add information such as “character” to the image IM1 while it is desired to set the image IM1 such as a character as a target for reducing the ink amount in the processing target inside portion F1 and the processing target edge portion E1. In this case, by setting only black, which is often used as a character or the like, as a target for reducing the ink amount, it is possible to extract the pixel PX0 in which the ink amount is to be reduced from the original image IM1 to reduce the ink amount in that pixel PX0 without requiring complicated processing for generating the dot data DA2. Further, when the object has a color other than white and the “OTHER THAN WHITE” item 242 is designated, even when the object is not black, a high-quality print image IM5 can be obtained by reducing the ink amount in the processing target inside portion F1 and the processing target edge portion E1with respect to the object having the color other than white. Therefore, it is possible to obtain a high-quality print image IM5 in accordance with the color of an object such as a thin oblique line or a barcode.

Note that even when an object such as a thin oblique line or a barcode has a color other than black such as blue or red, the print control processing of FIG. 3 may be performed taking that color as a predetermined color included in the plurality of options 240.

Further, the surrounding area AR2 is not limited to the white area having the pixel values (R, G, B)=(255, 255, 255). For example, denoting an integer value larger than 128 and smaller than 255 by GR, the surrounding area AR2 may be an area of the pixels PX0 in a light color satisfying R≥GR, G≥GR, and B≥GR. In this case, the dark area AR3 is an area in a dark color satisfying R≤GR−1, G≤GR−1, or B≤GR−1. The predetermined color range included in the plurality of options 240 may be a color range satisfying R≤GR−1, G≤GR−1, or B≤GR−1.

Further, in order to switch the depth of the processing target inside portion F1 in the print control processing illustrated in FIG. 3, the printing apparatus 1 can display an edge depth designation screen 560 illustrated in FIG. 10C on at least one of the output unit 25 of the operation panel 24 and the display device DU1 of the host apparatus HO1. FIG. 10C schematically illustrates a display example of the edge depth designation screen 560. FIG. 11 schematically illustrates a state of deepening the processing target inside portion F1 to generate the corrected image IM3. For the sake of convenience, the first corner pixel PX31 and the second corner pixel PX32 are attached to a reference pattern P20.

The edge depth designation screen 560 illustrated in FIG. 10C includes a plurality of options for designating the depth of the processing target inside portion F1, such as a “1-DOT DEPTH” item 261 and a “2-DOT DEPTH” item 262. The “1-DOT DEPTH” item 261 is an option for setting the depth of the processing target inside portion F1 to one dot. The “2-DOT DEPTH” item 262 is an option for setting the depth of the processing target inside portion F1 to approximately two dots in the X direction and the Y direction. For example, the controller 10 causes the output unit 25 to display the edge depth designation screen 560, and receives, in the input unit 26 of the operation panel 24, designation of any one of the plurality of options (261, 262). When the designation of the “1-DOT DEPTH” item 261 is received, the controller 10 detects the processing target inside portion F1 from the image IM1 by pattern matching using the reference pattern P0 of 3×3 pixels illustrated in FIG. 5 in the detection processing in S102 illustrated in FIG. 3. When the designation of the “2-DOT DEPTH” item 262 is received, the controller 10 detects the processing target inside portion F1 from the image IM1 by pattern matching using the reference pattern P20 illustrated in FIG. 11 in the detection processing in S102 illustrated in FIG. 3. Obviously, the host apparatus HO1 may cause the display device DU1 to display the edge depth designation screen 560, and receive, in the input unit (not illustrated), designation of any one of the plurality of options (261, 262). In any case, the edge depth designation step ST5 of receiving the designation of the depth of the processing target inside portion F1 is performed. The controller 10 or the host apparatus HO1 performs detection processing of detecting the processing target inside portion F1 so as to achieve the designated depth.

The reference pattern P20 shown in FIG. 11 includes the reference patterns P1, P2 of 3×3 pixels and reference patterns P21, P22 of 5×5 pixels. As shown in FIG. 5, the reference pattern P1 of 3×3 pixels has an arrangement in which the first corner pixel PX31 is a light pixel and the remaining eight pixels are dark pixels, and is capable of detecting the processing target inside portion F1 located at a position with one-dot depth along the upper left edge in the left-downward area AR4. As shown in FIG. 5, the reference pattern P2 of 3×3 pixels has an arrangement in which the second corner pixel PX32 is a light pixel and the remaining eight pixels are dark pixels, and is capable of detecting the processing target inside portion F1 located at a position with one-dot depth along the upper right edge in the right-downward area AR5. The reference pattern P21 of 5×5 pixels has an arrangement in which the first corner pixel PX31 and two pixels adjacent to the first corner pixel PX31 are light pixels and the remaining 22 pixels are dark pixels, and is capable of detecting the processing target inside portion F1 located at a position with two-dot depth along the upper left edge in the left-downward area AR4. The reference pattern P22 of 5×5 pixels has an arrangement in which the second corner pixel PX32 and two pixels adjacent to the second corner pixel PX32 are light pixels and the remaining 22 pixels are dark pixels, and is capable of detecting the processing target inside portion F1 located at a position with two-dot depth along the upper right edge in the right-downward area AR5. In the reference patterns P21, P22 of 5×5 pixels, since the target pixel PX1 and both sides in the X direction and the Y direction of the target pixel PX1 are dark pixels, it can be said that the cross area PX10 is in the dark area AR3. Note that the “depth” in the example illustrated in FIG. 11 means a depth in the X direction and a depth in the Y direction.

For example, the controller 10 can sequentially set the target pixel PX1 from the image IM1 to perform the pattern matching in which the reference pattern P20 is applied to a determination area centered on the target pixel PX1. Here, the controller 10 sets a determination area of 3×3 pixels around the target pixel PX1 for the application of the reference patterns P1, P2, and sets a determination area of 5×5 pixels around the target pixel PX1 for the application of the reference patterns P21, P22. Due to the reference pattern P20, regarding the left-downward area AR4 and the right-downward area AR5, not only pixels at a distance of one pixel from the surrounding area AR2 in the first direction D1 or the second direction D2 but also pixels at a distance of two pixels from the surrounding area AR2 in the first direction D1 or the second direction D2 can be the processing target inside portion F1.

In this way, the depth of the processing target inside portion F1 to be detected can be adjusted to the intention of the user. Therefore, the image quality of the print image is improved in accordance with the intention of the user.

Further, in order to switch the detection target area AR1 in the print control processing illustrated in FIG. 3, the printing apparatus 1 can display an object designation screen 580 illustrated in FIG. 12A on at least one of the output unit 25 of the operation panel 24 and the display device DU1 of the host apparatus HO1. FIG. 12A schematically illustrates a display example of the object designation screen 580. FIG. 12B schematically illustrates the detection target area AR1 belonging to the image IM1.

The object designation screen 580 illustrated in FIG. 12A includes a plurality of options for designating the detection target area AR1, such as a “CHARACTER AND LINE” item 281 and a “WHOLE” item 282. The “CHARACTER AND LINE” item 281 is an option for setting the detection target area AR1 to a character and a line (including a barcode). A characters and a line are examples of objects belonging to the image IM1. The “WHOLE” item 282 is an option for setting the detection target area AR1 to the whole of the image IM1. For example, the controller 10 causes the output unit 25 to display the object designation screen 580, and receives, in the input unit 26 of the operation panel 24, designation of any one of the plurality of options (281, 282). When the designation of the “CHARACTER AND LINE” item 281 is received, as illustrated in FIG. 12B, the controller 10 extracts the character area AR1c and the line area AR1b from the image IM1 as the detection target area AR1. Information representing the positions of characters and lines is often associated with the image IM1. For example, when the image IM1 is derived from an image file having the information representing attributes of characters and lines, the controller 10 may acquire the information representing positions of characters and lines derived from the image file from the host apparatus HO1 or the like. When the designation of the “WHOLE” item 282 is received, the controller 10 treats the whole of the image IM1 as the detection target area AR1. Obviously, the host apparatus HO1 may cause the display device DU1 to display the object designation screen 580, and receive, in the input unit (not illustrated), designation of any one of the plurality of options (281, 282). In either case, the object designation step ST6 of designating an object belonging to the image IM1 is performed. The controller 10 or the host apparatus HO1 performs detection processing of detecting the processing target inside portion F1 or the processing target edge portion E1 taking the areas (AR1c, AR1b) of the designated object as the detection target area AR1.

In this way, the detection target area AR1 can be adjusted to the intention of the user. Therefore, the image quality of the print image is improved in accordance with the intention of the user. In particular, characters and lines (including barcodes) have a large effect of reducing the ink amount in the processing target inside portion F1 or the processing target edge portion E1.

Note that the object may be either one of a character and a line.

### (4) Modified Examples

Various modified examples of the present disclosure are conceivable.

For example, the combination of ink colors is not limited to C, M, Y, and K, and may include orange, green, light cyan lower in density than C, light magenta lower in density than M, dark yellow higher in density than Y, and light black lower in density than K. Obviously, the aspects of the present disclosure can also be applied to when the printing apparatus 1 does not use any of the C ink, the M ink, the Y ink, and the K ink.

The detection of the processing target inside portion F1 is not limited to the pattern matching. For example, the printing apparatus 1 may detect the target pixel PX1 as the processing target inside portion F1 when it is confirmed that the first corner pixel PX31 is a light pixel and the remaining eight pixels are dark pixels for each pixel PX0 of the determination area AD0 of 3×3 pixels, and may detect the target pixel PX1 as the processing target inside portion F1 when it is confirmed that the second corner pixel PX32 is a light pixel and the remaining eight pixels are dark pixels for each pixel PX0 of the determination area AD0 of 3×3 pixels.

The detection of the processing target edge portion E1 is not limited to the pattern matching. For example, the printing apparatus 1 may detect, as the first edge portion E11, the target pixel whose filter calculation value using a horizontal Sobel filter is larger or smaller than a predetermined threshold value in the dark area AR3. In addition, the printing apparatus 1 may detect, as the second edge portion E12, the target pixel whose filter calculation value using the vertical Sobel filter is larger or smaller than a predetermined threshold value in the dark area AR3. Further, the printing apparatus 1 may detect the whole of the edge E0 by a filter calculation using a Laplacian filter in the dark area AR3, and then detect the processing target edge portion E1 based on the position of the light pixel adjacent to the dark pixel located at the edge E0.

In the specific example described above, the ink amount in the processing target inside portion and the processing target edge portion is reduced by detecting the processing target inside portion and the processing target edge portion from the RGB image, but this is not a limitation. For example, the control unit may detect the processing target inside portion and the processing target edge portion from the CMYK image expressed by the ink amount data to reduce the ink amount in the processing target inside portion and the processing target edge portion. Further, the control unit may generate the corrected dot data by detecting the processing target inside portion and the processing target edge portion from the dot image expressed by the dot data before the correction to thin or reduce the size of the dots in the processing target inside portion and the processing target edge portion.

### (5) Conclusions

As described above, according to the present disclosure, it is possible to provide a configuration and so on capable of suppressing the degradation of the printing quality due to bleeding of ink while suppressing the deterioration of an oblique edge portion in the two oblique directions with various aspects. Obviously, the basic functions and advantages described above can be provided even in an aspect including only the elements according to the independent claims.

In addition, it is conceivable to employ a configuration in which the elements disclosed in the examples described above are interchanged with each other or the combination of the elements is changed, a configuration in which the elements disclosed in known technologies and the examples described above are interchanged with each other or the combination of the elements is changed, and the like. The present disclosure also includes the configurations described above and the like.

What is claimed is:

1. A method of generating dot data configured to represent positions of dots to be formed of ink from a print head, wherein
an image including a plurality of pixels arranged in a first direction and a second direction crossing the first direction includes a surrounding area and a dark area darker than the surrounding area,
the method comprising:
a detection step of detecting a target pixel belonging to at least a part of a detection target area of the image as a processing target inside portion when a rectangular determination area centered on the target pixel satisfies a predetermined edge inside condition including the surrounding area and the dark area; and
a generation step of generating the dot data from the image so that an amount of the ink ejected from the print head to the processing target inside portion is reduced, wherein
the determination area includes a cross area including the target pixel and both sides of the target pixel in the first direction and the second direction in the determination area, and corner pixels at four corners of the determination area,
the corner pixels located at the four corners including a first corner pixel and a second corner pixel that is not located at a diagonal position from the first corner pixel in the determination area, and
in the detection step,
the target pixel is detected as the processing target inside portion when a first condition that the cross area is located in the dark area, the first corner pixel is located in the surrounding area, and the three corner pixels other than the first corner pixel are located in the dark area is satisfied in the determination area as the edge inside condition, and
the target pixel is detected as the processing target inside portion when a second condition that the cross area is located in the dark area, the second corner pixel is located in the surrounding area, and the three corner pixels other than the second corner pixel are located in the dark area is satisfied in the determination area as the edge inside condition.

2. The method of generating the dot data according to claim 1, wherein
in the detection step, at least one of a first edge portion located at one side in the dark area in the first direction and a second edge portion located at one side in the dark area in the second direction out of edges existing in the detection target area is detected as a processing target edge portion, and
in the generation step, the dot data is generated from the image so that an amount of the ink ejected from the print head to the processing target edge portion is reduced.

3. The method of generating the dot data according to claim 2, wherein
in the generation step, an amount of the ink ejected from the print head to the processing target edge portion is made smaller than an amount of the ink ejected from the print head to the processing target inside portion.

4. The method of generating the dot data according to claim 1, further comprising
a color designation step of receiving designation of an option to be applied to the dark area out of a plurality of options including a predetermined color and a predetermined color range, wherein
in the detection step,
when the predetermined color is designated, the target pixel is detected as the processing target inside portion when a distribution of the dark area having the predetermined color and the surrounding area satisfies the edge inside condition in the determination area, and
when the predetermined color range is designated, the target pixel is detected as the processing target inside portion when a distribution of the dark area in the predetermined color range and the surrounding area satisfies the edge inside condition in the determination area.

5. The method of generating the dot data according to claim 1, further comprising
an edge depth designation step of receiving designation of a depth of the processing target inside portion, wherein
in the detection step, the processing target inside portion is detected so as to achieve the depth designated.

6. The method of generating the dot data according to claim 1, further comprising
an object designation step of designating an object belonging to the image, wherein
in the detection step, the processing target inside portion is detected taking an area of the object designated as the detection target area.

7. A printing apparatus configured to form a print image at a print medium with ink, the apparatus comprising:
a print head configured to eject the ink; and
a control unit configured to control ejection of the ink from the print head to the print medium so that dots constituting the print image are formed at the print medium, wherein
an image including a plurality of pixels arranged in a first direction and a second direction crossing the first direction includes a surrounding area and a dark area darker than the surrounding area,
the control unit executes
detection processing of detecting a target pixel belonging to at least a part of a detection target area of the image as a processing target inside portion when a rectangular determination area centered on the target pixel satisfies a predetermined edge inside condition including the surrounding area and the dark area, and
ejection control processing of controlling ejection of the ink from the print head to the print medium so that an amount of the ink ejected to the processing target inside portion is reduced,
the determination area includes a cross area including the target pixel and both sides of the target pixel in the first direction and the second direction in the determination area, and corner pixels at four corners of the determination area,
the corner pixels located at the four corners including a first corner pixel and a second corner pixel that is not located at a diagonal position from the first corner pixel in the determination area, and
in the detection processing, the control unit is configured to
detect the target pixel as the processing target inside portion when a first condition that the cross area is located in the dark area, the first corner pixel is located in the surrounding area, and the three corner pixels other than the first corner pixel are located in the dark area is satisfied in the determination area as the edge inside condition, and
detect the target pixel as the processing target inside portion when a second condition that the cross area is located in the dark area, the second corner pixel is located in the surrounding area, and the three corner pixels other than the second corner pixel are located in the dark area is satisfied in the determination area as the edge inside condition.
